(19) United States
(12) Patent Application Publication
(10) Pub. No.: US 2013/0199841 A1
(43) Pub. Date: Aug. 8, 2013

(54) METHOD FOR PREFABRICATING CABLES AND PREFABRICATED CABLE

(71) Applicant: Lutz Lehmann, Vilsbiburg (DE)

(72) Inventor: Lutz Lehmann, Vilsbiburg (DE)

(73) Assignee: Lisa Draeximaier GmbH, Vilsbiburg (DE)

(21) Appl. No.: 13/638,309

(22) PCT Filed: Mar. 23, 2011
(86) PCT No.: PCT/EP11/54443

§ 371 Date: Dec. 18, 2012

(30) Foreign Application Priority Data
Apr. 1, 2010 (DE) 10 2010 003 599.

(51) Int. Cl. H02G 1/14; H01R 4/20

(52) U.S. Cl. CPC H02G 1/14; H01R 4/20
USPC 174/75 R; 29/876

(57) ABSTRACT

A method is provided for prefabricating a cable. The method involves introducing an elongate, pin-shaped abutment at the end of a cable between exposed individual wires of a litz-wire conductor of the cable, positioning a sleeve around the outer circumference of the exposed litz-wire conductor, such that the sleeve surrounds at least one partial length of the exposed litz-wire conductor and of the abutment, and compressing the sleeve so that a contact part, which is connected to the sleeve and/or the abutment, is electrically connected to the litz-wire conductor. A cable prefabricated with this method is also provided.

The present invention relates to prefabricating cables. In particular, the present invention relates to the contacting of cables comprising light metal litz wires, for example aluminum litz wires. However, the invention is also transferable to other litz wire materials, for example magnesium and copper litz wires or to litz wires made from alloys composed of one or a plurality of the materials referred to previously or other suitable materials. Such cables are used mainly in motor vehicle construction to supply electrical consumers with electric power. Such cables are also used for grounding electrical systems. In addition to the method for prefabricating cables, the present invention also relates to a prefabricated cable.

Above all in motor vehicle construction, there has long been a desire, for weight-saving reasons and the substitution of expensive metals for more reasonably priced alternatives, to fabricate electric cables out of light metal, for example magnesium or aluminum or alloys thereof. However, when contacting these cables electrically to a contact element which, particularly in motor vehicles, is exposed to a dynamic load over a long period of many years, problems occur with regard to maintaining the contact particularly due to the material's cold flow tendency, i.e. the tendency of light metals such as aluminum and magnesium to break down mechanical stresses in the microstructure even at low temperatures, and due above all, in the case of aluminum alloys, to an oxide layer which exists on the surfaces of the aluminum alloy, and finally due to the risk of electrochemical corrosion in the joining region of the light metal litz wires to the contact elements in the presence of electrolytes. There has long been a need, therefore, to also provide a permanently resistant contacting of light metal litz wires with contact elements under the present circumstances.

To solve this problem, DE 10 2008 031 588 A1 proposes to bond light metal litz wires to a contact element using an ultrasonic welding process wherein first of all a sleeve is cold-welded to the exposed ends of the light metal litz wire using the ultrasonic welding process. This sleeve is then used for contacting with the contact element. The ultrasonic welding process takes between 500 and 1,500 ms. Alternatively known soft or hard soldering processes actually take several seconds.

An alternative method is disclosed in WO 2008/104668 A1. This method uses a magnetic pulse welding process by means of which the sleeve of a cable lug is cold-welded to the exposed litz wire of a cable as the contact element. In this case the sleeve, by analogy with known mechanical crimping or caulking, is pressed onto the litz wire from the outside with extreme acceleration using the magnetic pulse welding process in order to create the contact with said litz wire. This method has the disadvantage that the effect of the magnetic pulse decreases towards the center of the litz wire. As a result, cold welding no longer takes place between the individual wires situated in the center which means that both the reliability of the mechanical joint between the contact element and the litz wire and also the joint's electrical conductivity is reduced.

Consequently, the object of the present invention is to create a method for prefabricating cables which with a comparatively short process duration guarantees more reliable contacting, by comparison with WO 2008/104668, of the contacting element with the litz-wire conductor of the cable even when using light metal litz wires. In addition to this, the present invention relates to the creation of a prefabricated cable which can be manufactured in a short process duration and therefore inexpensively and which enables more reliable contacting of contact elements with the litz-wire conductor of the cable even when using light metal as the conductor material.

The above objects are accordingly achieved by means of a method for prefabricating cables having the features of claim 1 and a prefabricated cable having the features of claim 5. Advantageous developments of the present invention may be found in the dependent claims.

The present invention is based on the concept of ensuring, by providing at least one abutment inside the litz-wire conductor, that the mechanical pulse is also transferred in the optimum manner to the inner individual wires and therefore to prevent a reduction in the quality of the electrical and mechanical contact towards the center.

Consequently, the present invention proposes a method for prefabricating cables. Prefabricating of cables in this context is to be understood as the production of ready-to-install cables, cable bunches or whole cable harnesses together with contact elements. Any connectors and contacts are included as contact elements within the meaning of the present invention. Cable lugs and round pins for high-voltage applications are mentioned purely by way of example. The cable to be prefabricated is typically a single-core cable with a litz-wire conductor. The cable may also, however, have a plurality of cores, i.e. litz-wire conductors electrically insulated from one another and additionally a shield such as is necessary, for example, for high-voltage applications. Unlike a solid conductor, a litz-wire conductor is composed of a plurality of individual wires. For the very large number of individual wires necessary in the case of large conductor cross-sections, a plurality of litz-wire conductors are also stranded together for reasons of symmetry which therefore results in turn in an approximately round cross-section of the conductor. The wires of a litz wire are preferably formed from a light metal or a light metal alloy, such as magnesium or aluminum or alloys thereof. Pure aluminum is especially preferable for use here due to its cost and weight advantage. The method according to the invention includes the introduction of a least one preferably elongate, in particular pin-shaped abutment on the end of a wire in a preferred embodiment into the center of the exposed litz-wire conductor, i.e. between the individual wires of the litz-wire conductor. For this purpose a partial length of the cable or the wire is stripped, preferably in a previous work step, in order to expose the litz wire. Introduction of the abutment may be carried out in such a way that first of all the individual wires of the litz-wire conductor are pushed apart in a separate step to create an appropriate space for the abutment. This procedure may be carried out, for example, by inserting a very pointed awl which is inserted between the individual wires and is removed again after pushing apart the litz-wire conductor. Alternatively, it is also conceivable to design the abutment itself with its front end pointed and to introduce it directly into the litz-wire conductor and during this procedure to push apart (the litz wires). That is to say, the abutment itself can be used to “deform” the litz-wire conductor. It is also conceivable to introduce a plurality of elements, e.g. pins, between the exposed individual wires of the litz-wire conductor which together form the abutment. A plurality of abutments is also possible which, for example, support each other and may be distributed symmetrically around the litz-wire conductor's central axis. The method according to the invention also includes the positioning of a sleeve around the outer circumference of the exposed litz-wire conductor. In this case, the sleeve is preferably positioned in such a way that it surrounds a partial length of the exposed litz-wire conductor and also a partial length of the abutment. That is to say, the sleeve surrounds the exposed litz-wire conductor and the abutment in at least a partial region. The sleeve may be pushed onto the cable in advance before the abutment is inserted into the litz-wire conductor. However, the reverse process or simultaneous application of the sleeve and introduction of the abutment is also conceivable. The latter, particularly if both the sleeve and also the abutment are designed integrally with the contact element (see later). The sleeve is preferably a sleeve with a closed, preferably circular cross-section. Finally, the method of the present invention includes firmly bonded joining (compression) of the sleeve to the litz wires and of the litz wires to the abutment as a result of which the contact element is electrically connected to the litz-wire conductor. According to the invention, the contact element may be joined to the sleeve and/or the abutment, in particular it may be formed integrally. In this respect, it is conceivable to design the contact element integrally with the sleeve or integrally with the pin. In these cases, the pin or the sleeve are accordingly separate elements which only enter into a connection with the other elements after the compression. Alternatively, it is also conceivable to design both the sleeve and also the pin integrally with the contact element. The pin and/or the sleeve may be formed from the same material as the contact element, i.e. of copper or alloys thereof or of the same material as the litz-wire conductor. However, it is also conceivable to design the sleeve and/or the pin of a material different to that of the contact element and/or the litz-wire conductor. In addition to the advantages mentioned above, the present invention offers the additional advantage that the method can be used for both the contacting of copper cables, i.e. copper litz wires, and also of aluminum cables, i.e. aluminum litz wires. In this case, the same contact element geometries and the same method can be used. It may merely be necessary if required to adapt the sleeve diameter to the cross-section which is larger in the case of aluminum than it is with copper.

According to an especially preferred embodiment of the present invention, firmly bonded joining (compression) is carried out by means of a pressure welding process. An ultrasonic welding process is a possibility here and the sleeve should be centered radially. For this reason and to reduce the process duration, a magnetic pulse welding process is preferred. Reference is made to WO 2008/104668 A1 referred to at the outset in respect of the magnetic pulse welding process. Unlike ultrasonic welding, use of the magnetic pulse welding process also enables high mechanical strengths and uniformly low contact resistances even with large cable cross-sections above 60 mm². By using a pressure welding process, the inner side of the sleeve is cold welded to the individual wires which are in contact with it. In addition, the individual wires which are in contact with each other are cold welded among themselves and the individual wires which are in contact with the abutment are cold welded to the abutment. As a result, a reliable welding of all the wires of the litz-wire conductor is accomplished with virtually constant quality in the radial direction.

In this respect, it is further preferable to introduce the abutment substantially centrally into the litz-wire conductor. This can be ensured in such a way that the exposed end of the litz wires is first held completely in a tool which specifies the maximum diameter after insertion of the abutment. Held in this tool, the abutment or a pin for forming a space for the abutment is inserted as has been described above. The pin is centered relative to the tool such that a central arrangement of the abutment relative to the litz-wire conductor can be guaranteed. When using an even number of individual wires, it is possible to arrange the abutment exactly centrally after which the individual wires spread out evenly around the abutment's circumference. With an uneven number of individual wires, it is only substantially possible to achieve the central arrangement since an individual wire, which is otherwise arranged centrally, has to yield radially. Within the meaning of the present application this is also to be understood by the term “centrally” and is identified in the claims by the notion “substantially”.

To make it easier to insert the abutment or the pin for forming a space for the abutment, it is preferable in the case of twisted litz wires to strip against the twist as a result of which the torsion in the region to be contacted is at least reduced and introduction of the abutment is rendered easier.

In addition to the method for prefabricating cables, the present invention also relates to a prefabricated, single-core or multi-core, shielded or unshielded cable, which for one or a plurality of wires comprises a pin (the abutment described above) arranged in the center of the litz-wire conductor, a sleeve pressed onto the outer circumference of the litz-wire conductor and a contact element, which is joined to the sleeve and/or the pin, is preferably designed integrally and is in electrical contact with the litz-wire conductor.

The cable concerned is preferably a round conductor having a longitudinal central axis and the pin is substantially aligned with the longitudinal axis. With regard to this, reference is made to the central introduction of the abutment described above.

Moreover, it is preferable that the individual wires of the litz-wire conductor are formed from aluminum or an aluminum alloy wherein the inner side of the sleeve is cold welded to the individual wires, the individual wires are cold welded among themselves and the individual wires are cold welded to the pin as has been explained above.

Further features and advantages of the present invention, which may be implemented singly or in combination with one or a plurality of the features referred to above are apparent from the following description of a preferred embodiment.

This description is provided with reference to the associated drawings which show:

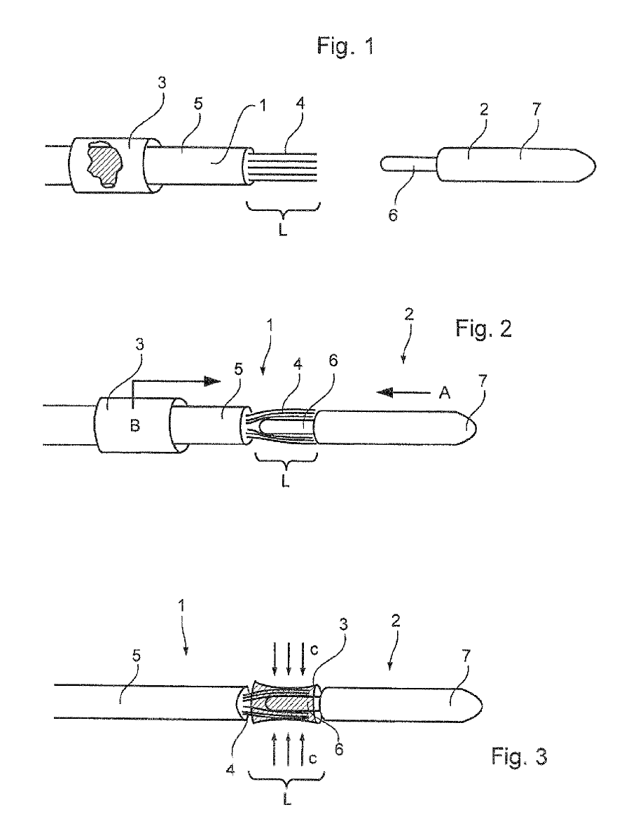

FIG. 1 a schematic view of a cable having a contact element according to the present invention prior to contacting;

FIG. 2 the combination from FIG. 1 in an intermediate step of the method according to the invention; and

FIG. 3 in schematic form the joining process for the combination from FIG. 1.

A preferred embodiment will be explained in the following description. It is understood, however, that the present invention can also be used on other cables with litz-wire conductors of a different material and for other contact elements. It is also conceivable that the contact element is not integrally joined to the abutment as described below but a connection can also be provided alternatively with the sleeve or with both elements. It is also possible to design the connection not integrally but, for example, firmly bonded, force fitted and/or form fitted.

FIG. 1 illustrates a cable 1 in schematic form. Cable 1 in the embodiment illustrated is a round conductor having a substantially circular cross-section. Cable 1 has a litz-wire conductor 4 which is formed of individual wires. Unlike as illustrated, litz-wire conductor 4 may be twisted or, as illustrated, may be formed of wires running parallel to each other. Moreover, cable 1 comprises an insulation 5 in the conventional sense which completely surrounds litz-wire conductor 4 and insulates against outside influences, such as is well known to the person skilled in the art. Cable 1 is stripped at one end of said cable 1 which is illustrated in FIG. 1. That is to say, litz-wire conductor 4 is exposed over a partial length L. Insulation 5 is no longer present in this area L. If litz wire 4 is twisted, stripping is carried out against the twist in order to align the individual wires substantially parallel to each other at least in end region L which makes subsequent insertion of pin 6 (also abutment) easier, in particular its central introduction.

In the embodiment illustrated, the individual wires of litz-wire conductor 4 are formed of pure aluminum or an aluminum alloy. However, copper litz wires, magnesium litz wires or litz wires of alloys of these metals can also be used.

Also illustrated in FIG. 1 is contact element 2. Contact element 2 is formed by contact part 7, e.g. a cable lug or a round pin (as illustrated). However, other contact parts, i.e. conventional contacts and/or connectors, are also conceivable as contact part 7. A pin 6 is designed integrally with contact part 7 in the embodiment illustrated. Pin 6 is an elongate abutment whose cross-sectional dimension (in particular diameter) is significantly smaller than the cross-sectional shape of litz-wire conductor 4 (in particular its diameter). If necessary, the cross-section of abutment 6 may correspond to the cross-section of litz-wire conductor 4. However, larger or smaller cross-sections are conceivable.

Moreover, FIG. 1 shows a sleeve 3 which in cross-section has a closed circular shape. The diameter in this case is slightly larger than the diameter of cable 1 with insulation 5. If necessary, it may also be that the sleeve can only be pushed over litz-wire conductor 4 in region L, but that the diameter is smaller than the diameter of cable 1 in the region of insulation 5. Sleeve 3 is designed to be thin-walled and preferably has a thickness between 0.1 mm and 0.5 mm. Sleeve 3 is preferably formed of metal, in particular copper or aluminum or an alloy of one of these metals. The sleeve may also have on its surface a metallic coating, such as silver.

Pin 6 is formed of metal and preferably has a hardness that is not less than the hardness of the individual wires of litz-wire conductor 4. Preferably a metal, in particular copper or aluminum or an alloy of one of these metals, is used. Furthermore, pin 6 may also have a metallic coating, such as silver. With an integral design, the contact part is formed of the same material. On the other hand, it is also conceivable to use different materials for pin 6 and contact part 7 and to join them together by means of an arbitrary joining process in a firmly bonded, force fitting and/or form fitting manner.

The method according to the invention is explained in the following according to an embodiment with reference to FIGS. 1 to 3.

As illustrated in FIG. 1, cable 1 is first completely stripped in region L. This can be carried out, as mentioned, against the twist of litz-wire conductor 4.

Then sleeve 3 is pushed onto cable 1 prepared in this manner.

Pin 6 together with contact part 7 is subsequently inserted into the stripped end of cable 1 between the individual wires of litz-wire conductor 4. In the process, litz-wire conductor 4 is divided in the center wherein ideally the individual wires distribute themselves evenly around the circumference of pin 6. Alternatively, it is also conceivable to first insert an awl between the individual wires of litz-wire conductor 4 in order to divide the litz-wire conductor in the center and to create a space for pin-shaped element 6, as has been explained previously in greater detail. So that the individual wires of litz-wire conductor 4 yield evenly, it may be advantageous to accommodate litz-wire conductor end L in a tool which surrounds it completely. This tool may be configured in two tool halves. This tool specifies the maximum circumference of litz-wire conductor 4 after division and, with a central introduction of pin 6, enables the individual wires of litz-wire conductor 4 to yield only in such a way that in the end pin 6 lies centrally in litz-wire conductor 4. However, this is only possible if there is an even number of individual wires. With an uneven number, the centrally positioned individual wire of the litz-wire conductor will yield in an arbitrary radial direction. This slight offset to the central arrangement, however, has no significantly negative effect on the joining result and falls within the notion of a central arrangement. After the insertion, pin 6 is substantially aligned with the central axis of cable 1. The insertion of pin 6 into litz-wire conductor 4 is indicated schematically by arrow A in FIG. 2.

Subsequently, sleeve 3, as indicated by arrow B in FIG. 2, is pushed over exposed length L of litz-wire conductor 4 or over at least a portion thereof. In this state, sleeve 3 completely surrounds one portion of length L of litz-wire conductor 4 and one portion of pin 6. In other words, sleeve 3 is at least arranged such that it surrounds both litz-wire conductor 4 and also pin 6 in a partial region.

In a next process step, as indicated by arrows C in FIG. 3, the sleeve is firmly bonded to litz-wire conductor 4 by means of a magnetic pulse welding process, as disclosed in WO 2008/104668 A1. To do this, a current is induced into the sleeve via a magnetic field, said current generating a magnetic field that is directed in the opposite direction to the outer magnetic field. As a result of the repulsive forces thus arising, the sleeve is compressed rapidly within microseconds and hits the outer litz wires at high speed. The energy released abruptly on impact breaks open existing oxide layers and leads to cold welding of the metal surfaces. During this process, the side of sleeve 3 lying radially on the inside is cold welded to the individual wires of litz-wire conductor 4 in contact with this inner side. The same applies to the individual wires of litz-wire conductor 4 which are in contact with each other and also to the individual wires of the litz-wire conductor which are in contact with pin 6. Due to the pulse, plastic deformation also takes place, particularly of the litz wires, as a result of which any existing voids in the litz-wire conductor are eliminated. However, it is essential for optimum firmly bonded contacting, which extends beyond mere compression of the litz wire, that maximum pulse transfer takes place between the joining partners. This is precisely what the appropriately dimensioned abutment in the center ensures and without which the energy transferred into the center by the pulse would be sufficient at best only to deform the individual wires located therein but would not be sufficient to cold weld them. Particularly in the case of aluminum litz wires, complete cold welding is in turn crucial for an optimum conductance of the electrical connection since, because of the natural oxide layer on the individual wires of the litz-wire conductor, there is no electrical conduction or only greatly reduced electrical conduction transverse to the conductor cross section.

Subsequently, electrical contacting of litz-wire conductor 4 to contact element 7 is established via pin 6. Unlike ultrasonic welding, this method enables high mechanical strength and uniformly low contact resistances even with large cable cross-sections above 60 mm². In addition to this, more uniform cold welding can be achieved in the radial direction than with a method in which no pin 6 is used but where only sleeve 3 is joined to contact part 7 which leads to more conductive, mechanically more stable and therefore also more reliable and more durable contacting. Moreover, the method can be used for both aluminum litz wires and also copper litz wires or litz wires with other materials without the method or contact element geometries having to be changed. It might merely be necessary if required to adjust the size of sleeve 3, i.e. to adapt its diameter to the relevant cable cross-section.

Accordingly, the present invention delivers a method with a short process duration, reliable contact result and flexibility of use. In addition, a prefabricated cable is created which has more reliable contacting that in the known prior art and is inexpensive to manufacture. It goes without saying, however, that the present invention can be implemented otherwise than described above with reference to the preferred embodiment, as was mentioned at the outset. The present invention is thus defined in the following claims.

1. A method for prefabricating a cable, the method comprising:
inserting at least one abutment on an end of a cable between exposed individual wires of a litz-wire conductor of the cable;
positioning a sleeve around the outer circumference of the exposed litz-wire conductor such that the sleeve surrounds at least one partial length of the exposed litz-wire conductor and of the abutment; and
compressing the sleeve so that a contact part, which is connected to the sleeve and/or the abutment, is electrically connected to the litz-wire conductor.

2. The method according to claim 1, wherein compressing the sleeve is effected by way of a pressure welding process, whereby the inner side of the sleeve is cold welded to the individual wires of litz-wire conductor, the individual wires of the litz-wire conductor in contact with each other are cold welded among themselves and the individual wires of the litz-wire conductor in contact with the abutment are cold welded to the abutment.

3. The method according to claim 1, wherein the abutment is inserted substantially centrally between the individual wires of the litz-wire conductor.

4. The method according to claim 1, further comprising stripping the end of the cable to expose the litz-wire conductor, wherein the individual wires of litz-wire conductor of the cable are twisted and the litz-wire conductor is stripped against the twist.

5. A prefabricated cable, comprising:
at least one core having a litz-wire conductor;
at least one abutment arranged between individual wires of the litz-wire conductor;
a sleeve pressed onto the outer circumference of the litz-wire conductor; and
a contact part connected to the sleeve and/or the abutment, the contact part being in electrical contact with the litz-wire conductor.

6. The prefabricated cable according to claim 5, wherein the cable is a round conductor having a longitudinal central axis and the abutment is substantially aligned with the longitudinal center axis.

7. The prefabricated cable according to claim 5, wherein the individual wires of the litz-wire conductor are formed of aluminum or an aluminum alloy.

8. The prefabricated cable according to claim 5, wherein the inner side of the sleeve is cold welded to the individual wires of the litz-wire conductor, the individual wires of the litz-wire conductor in contact with each other are cold welded among themselves and the individual wires of the litz-wire conductor in contact with the abutment are cold welded to the abutment.

9. The prefabricated cable according to claim 5, wherein the contact part is designed integrally with the litz-wire conductor.

10. The method according to claim 2, wherein compressing the sleeve is effected by way of a magnetic pulse welding process.
